(19) United States
(12) Patent Application Publication
(10) Pub. No.: US 2016/0372815 A1
(43) Pub. Date: Dec. 22, 2016

(54) GLASS ANTENNA FOR VEHICLE, AND WINDOW GLASS FOR VEHICLE

(71) Applicant: ASAHI GLASS COMPANY, LIMITED, Tokyo (JP)

(72) Inventors: Takuji HAYASHI, Tokyo (JP); Koki MIKAMO, Tokyo (JP); Tsuyoshi YAMAMOTO, Tokyo (JP)

(73) Assignee: ASAHI GLASS COMPANY, LIMITED, Tokyo (JP)

(21) Appl. No.: 15/253,068

(22) Filed: Aug. 31, 2016

Related U.S. Application Data
(63) Continuation of application No. PCT/JP2015/055234, filed on Feb. 24, 2015.

(30) Foreign Application Priority Data
Mar. 12, 2014 (JP) 2014-048702

(51) Int. Cl. H01Q 1/12

(52) U.S. Cl. CPC H01Q 1/1278

(57) ABSTRACT

A glass antenna for a vehicle such that a window glass plate is provided with an electric heating type defogger, a first antenna conductor, and a first feeding point, wherein the defogger is vertically divided, the first antenna conductor includes an area forming element, and a first antenna element, wherein both edges of the area forming element are connected to the first defogger to form a closed area that is closed, and wherein the first antenna element is formed in the closed area, the first antenna element is connected to the first feeding point connected to the area forming element, the first antenna element includes a first horizontal element, the first horizontal element is proximate to the first defogger, and the first horizontal element extends along the first defogger.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2015/055234 filed on Feb. 24, 2015 and designating the U.S., which claims priority of Japanese Patent Application No. 2014-048702 filed on Mar. 12, 2014. The entire contents of the foregoing applications are incorporated herein by reference.

### BACKGROUND OF THE INVENTION

1. Field of the Invention

The present disclosure relates to a glass antenna for a vehicle, and a window glass for a vehicle.

2. Description of the Related Art

A technique has been known, so far, which is for using, as an antenna or a part of an antenna, an electric heating type defogger, which is formed in a window glass for a vehicle, and which includes a plurality of heater lines; and a bus bar that is connected to an edge of the plurality of heater lines to feed power.

In general, when a defogger is used as an antenna, coils are connected between a bus bar and a power supply, and between the bus bar and ground; and a direct electric current is caused to flow, but it is necessary to block a signal that is in a frequency band to be received by the defogger. However, since a relatively large electric current flows through the defogger, such as from several amperes to several tens amperes, it is necessary to provide a coil with large current capacity that uses a thick conductor, and a problem arises that the coil is enlarged and becomes heavy.

For example, in Patent Document 1 (Japanese Unexamined Patent Publication No. 2009-017300), Patent Document 2 (Japanese Unexamined Patent Publication No. H11-088025), and Patent Document 3 (Japanese Unexamined Utility Model Publication No. H06-19305), a technique is disclosed such that the defogger is divided, and only a part of the defogger is used as an antenna. By arranging in such a manner that only a part of the defogger is used as an antenna, an electric current to flow through the defogger can be reduced, and current capacity required for the coil can be reduced; consequently, the coil can be downsized.

However, there has been a case where, when the defogger is divided and an antenna pattern uses a part of the heater line, as in Patent Documents 1, 2, and 3, gain is lowered in an FM band, especially in an FM band outside Japan.

In view of the above, it is desired to provide a glass antenna for a vehicle with which sufficient antenna performance can be obtained for the FM band, even if the defogger is divided and the antenna pattern uses a part of the heater line.

### SUMMARY OF THE INVENTION

According to an aspect of the present invention, there is provided a glass antenna for a vehicle such that a window glass plate of the vehicle is provided with an electric heating type defogger including a plurality of heater lines, and a plurality of bus bars for feeding power to the heater lines; a first antenna conductor; and a first feeding point for the first antenna conductor, the defogger is vertically divided, and the defogger includes a first defogger including a first plurality of heater lines and a first pair of bus bars, and a second defogger including a second plurality of heater lines and a second pair of bus bars, wherein the first antenna conductor includes an area forming element, and a first antenna element, wherein both edges of the area forming element are connected to the first defogger, and the area forming element is formed along an outer edge of the window glass plate to form a closed area that is closed by the area forming element and the first defogger, wherein the first feeding point is electrically connected to the area forming element, wherein the first antenna element is formed in the closed area, the first antenna element includes a first horizontal element, and the first antenna element is connected to the first feeding point directly or through a first connecting element, and wherein the first horizontal element is proximate to the first defogger, and the first horizontal element extends along the first defogger.

According to another aspect of the present invention, there is provided a window glass for a vehicle, the window glass including a glass antenna for the vehicle such that a window glass plate of the vehicle is provided with an electric heating type defogger including a plurality of heater lines, and a plurality of bus bars for feeding power to the heater lines; a first antenna conductor; and a first feeding point for the first antenna conductor, wherein the defogger is vertically divided, and the defogger includes a first defogger including a first plurality of heater lines and a first pair of bus bars, and a second defogger including a second plurality of heater lines and a second pair of bus bars, wherein the first antenna conductor includes an area forming element, and a first antenna element, wherein both edges of the area forming element are connected to the first defogger, and the area forming element is formed along an outer edge of the window glass plate to form a closed area that is closed by the area forming element and the first defogger, wherein the first feeding point is electrically connected to the area forming element, wherein the first antenna element is formed in the closed area, the first antenna element includes a first horizontal element, and the first antenna element is connected to the first feeding point directly or through a first connecting element, and wherein the first horizontal element is proximate to the first defogger, and the first horizontal element extends along the first defogger.

According to another aspect of the present invention, there is provided a glass antenna for a vehicle to be connected to a first defogger including a first plurality of heater lines and a first pair of bus bars, and to a second defogger including a second plurality of heater lines and a second pair of bus bars, the glass antenna for the vehicle including a first antenna conductor; and a first feeding point for feeding power to the first antenna conductor, wherein the first antenna conductor includes an area forming element, and a first antenna element, wherein, when the area forming element is formed in a window glass plate, the area forming element is arranged along an outer edge of the window glass plate, and both edges of the area forming element are connected to the first defogger, so that a closed area that is closed by the area forming element and the first defogger is formed, and wherein, when the first antenna element is formed in the window glass plate, the first antenna element is arranged in the closed area, and the first antenna element includes a part, the part being proximate to the first defogger, and the part being extended along the first defogger.

According to at least one embodiment, a glass antenna for a vehicle is provided, with which sufficient antenna performance can be obtained, even if a defogger is divided and an antenna pattern uses a part of a heater line.

Other objects, features and advantages of the present invention will become more apparent from the following detailed description when read in conjunction with the accompanying drawings.

### BRIEF DESCRIPTION OF THE DRAWINGS

FIG. 1 is a plan view of a window glass for a vehicle with a glass antenna, in which the glass antenna according to a first embodiment is formed;

FIG. 2 is a plan view of the window glass for the vehicle with a glass antenna, in which the glass antenna according to a second embodiment is formed;

FIG. 3 is an example where a specification of the second embodiment is modified;

FIG. 4 shows, in the first embodiment, data indicating an effect on gain of horizontally polarized wave of a Japan domestic FM radio broadcast wave, which is caused by division of a defogger and an area forming element;

FIG. 5 shows, in the second embodiment, data indicating an effect on the gain of the horizontally polarized wave of the domestic FM radio broadcast wave, which is caused by the division of the defogger and the area forming element;

FIG. 6 shows, in the second embodiment, data indicating an effect on gain of vertically polarized wave of the domestic FM radio broadcast wave, which is caused by the division of the defogger and the area forming element;

FIG. 7 shows actually measured data of obtained antenna gain in the first embodiment; and

FIG. 8 shows actually measured data of obtained antenna gain in the second embodiment.

### DESCRIPTION OF THE PREFERRED EMBODIMENTS

An embodiment of the present invention is described below by referring to the accompanying drawings Note that, in the drawings for describing the embodiment, for parallel lines, a right angle, curvature of a corner, and so forth, a deviation is allowed to the extent that the effect of the present invention is not reduced. Further, the drawings are diagrams that are viewed from inside a vehicle when a window glass for the vehicle is attached to the vehicle; however, these may be referred to as the diagrams that are viewed from outside the vehicle. Furthermore, on the drawings, the horizontal direction corresponds to a vehicle width direction.

### First Embodiment

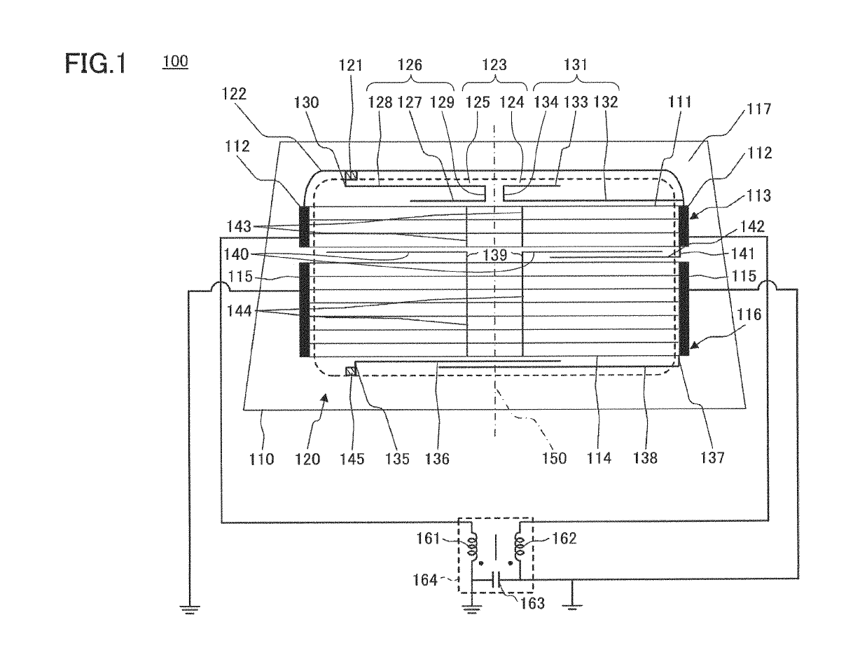

FIG. 1 is a plan view of a window glass 100 for a vehicle with a glass antenna, in which a glass antenna 120 (a glass antenna for a vehicle) according to a first embodiment is provided.

As illustrated in FIG. 1, in a window glass plate 110 for the vehicle, an electric heating type defogger, a first antenna conductor, and a first feeding point for the first antenna conductor are formed.

The defogger is vertically divided, and the defogger includes a first defogger 113; and a second defogger 116, which are mutually separated. The first defogger 113 includes a first plurality of heater lines 111 and a first pair of bus bars 112; and the second defogger 116 includes a second plurality of heater lines 114 and a second pair of bus bars 115.

The first plurality of heater lines 111 and the second plurality of heater lines 114 are extended in the horizontal direction of the glass for the vehicle; and the first pair of bus bars 112 and the second pair of bus bars 115 are extended in the vertical direction. Both ends of the first plurality of heater lines 111 are respectively connected to the first pair of bus bars 112; and both ends of the second plurality of heater lines 114 are respectively connected to the second pair of bus bars 115. At a margin of the window glass plate 110 for the vehicle, which is at an upper portion of the first defogger 113, the first antenna conductor is formed.

The first antenna conductor includes an area forming element 122; a first antenna element 126; and a second antenna element 131.

Both ends of the area forming element 122 are connected to the first defoggers 113; and the area forming element 122 is formed along an outer edge of the window glass plate for the vehicle, so that a closed area 123 is formed at the margin at the upper portion of the first defogger 113 by the first defogger 113 and the area forming element 122.

The closed area 123 is divided into two areas, which are a right closed area 124 and a left closed area 125, by a center line 150 in the vertical direction that passes through a centroid of the window glass plate for the vehicle, as a boundary line (when is not necessary to describe by distinguishing the right closed area 124 and the left closed area 125, they are simply referred to as the closed area 123, hereinafter).

Here, as for a size of the closed area 123, it suffices if the first antenna element 126, which is described below, can be arranged in the closed area 123. Further, it is desirable, for aesthetic purposes, that the area forming element 122 is formed in an area that is shielded by a black shielding film 117.

The black shielding film 117 is formed with a predetermined width from an outer edge of the window glass plate 110 for the vehicle; and the black shielding film 117 exists, in FIG. 1, in an area from the outer edge of the window glass plate 110 for the vehicle to a dashed line. The black shielding film 117 is formed to prevent deterioration of an adhesive at a bonded portion between the window glass plate 110 for the vehicle and a metal part of the vehicle body, and for aesthetic purposes. Note that, in FIG. 1, it is indicated that both end portions of the area forming element 122 are connected to the upper ends of the first pair of the bus bars 112, respectively; however, this is merely an example, which is not intended to limit. For example, one of or both the end portions of the area forming element 122 may be connected to any portion of the first pair of bus bars 112.

The first antenna element 126 is formed inside the closed area 123. The first antenna element 126 includes a first horizontal element 127; a second horizontal element 128; and a first vertical element 129; and the first antenna element 126 is connected to the first feeding point 121 through a first connecting element 130.

The first horizontal element 127 may be proximate to the first defogger 113; and the first horizontal element 127 may be extended along the first defogger 113. No other conductors may exist between the first horizontal element 127 and the first defogger 113. The second horizontal element 128 runs parallel to the first horizontal element 127, while it is separated from the first horizontal element 127 by a predetermined interval; and one end of the first vertical element 129 is connected to the first horizontal element 127 and the other end is connected to the second horizontal element 128. The second horizontal element 128 may be connected to the first feeding point 121 through the first connecting element 130.

By forming such a first antenna element 126, the obtained antenna gain is increased.

Note that, in the embodiment, the first antenna element 126 includes the first horizontal element 127, the second horizontal element 128, and the first vertical element 129; however it is not limited to this. If the element length of the first horizontal element 127 is sufficient, it may formed only of the first horizontal element 127. In this case, the first horizontal element 127 may be connected to the first feeding point 121 through at least one of the vertical element and the connecting element.

Further, the example is illustrated where the first vertical element 129 is connected to the end portions of the first horizontal element 127 and the second horizontal element 128; however, the first vertical element 129 may be connected to middle parts of any of them.

Furthermore, the example is illustrated where the first connecting element 130 is connected to the end portion of the second horizontal element 128; however, the first connecting element 130 may be connected to any part of the first antenna element 126. Additionally, the first antenna element 126 may be directly connected to the feed point 121, without forming the first connecting element 130.

Note that, in the present specification, “runs parallel to” is interpreted to have a certain range, to the extent that the effect is not reduced. For example, the second horizontal element 128 may not be precisely parallel to the first horizontal element 127; and the second horizontal element 128 may have an angle such that it intersects the first horizontal element 127 with a predetermined angle.

The second antenna element 131 is an optional component. The second antenna element 131 is formed inside the closed area 123. The second antenna element 131 includes a third horizontal element 132, a fourth horizontal element 133, and a second vertical element 134; and an end portion of the third horizontal element 132 is connected to the area forming element 122.

The third horizontal element 132 may be proximate to the first defogger 113; and the third horizontal element 132 may be extended along the first defogger 113. No other conductors may exist between the third horizontal element 132 and the first defogger 113. The fourth horizontal element 133 runs in parallel to the third horizontal element 132, while it is separated from the third horizontal element 132 by a predetermined interval; and one end of the second vertical element 134 is connected to the third horizontal element 132 and the other end is connected to the fourth horizontal element 133.

By forming such a second antenna element 131, the obtained antenna gain is increased. Note that, in the embodiment, the second antenna element 131 includes the third horizontal element 132, the fourth horizontal element 133, and the second vertical element 134; however, the second antenna element 131 is not limited to this. If the element length of the third horizontal element 132 is sufficient, it may formed only of the third horizontal element 132.

Further, the example is indicated where the second vertical element 134 is connected to the end portions of the third horizontal element 132 and the fourth horizontal element 133; however, the second vertical element 134 may be connected to middle parts of any of them.

Furthermore, the second antenna element 131 may be connected to the area forming element 122 through a second connecting element, which is not depicted. At this time, the second connecting element may be connected to any part of the second antenna element 131.

Additionally, in FIG. 1, the first antenna element 126 is formed in the left closed area 125; and the second antenna element 131 is formed in the right closed area 124. By forming in the respective different areas, particularly large antenna gain can be obtained.

Additionally, the first antenna element 126 and the second antenna element 131 are formed to be approximately symmetrical with respect to the center line 150, as an axis of symmetry; and by forming in such a manner, particularly large antenna gain can be obtained.

Note that the first antenna element 126 may be formed in the right closed area 124, and the second antenna element 131 may be formed in the left closed area 125. Further, the first antenna element 126 and the second antenna element 131 may be formed across the right closed area 124 and the left closed area 125, respectively.

Note that, in the embodiment, it is preferable that the element length from the first feeding point 121 to the tip of the first antenna element 126 (which is referred to as the element length of the first antenna element 126, hereinafter), and the element length from the connecting point of the area forming element 122 to the tip of the second antenna element 131 (which is referred to as the element length of the second antenna element 131, hereinafter) be a desired length. Specifically, it suffices if the element length is greater than or equal to (⅛)·λ_{g} and less than or equal to (⅜)·λ_{g}, and more preferably greater than or equal to (¼)·λ_{g} and less than or equal to (⅜)·λ_{g}; or greater than or equal to (⅝)·λ_{g} and less than or equal to (⅞)·λ_{g}, and more preferably greater than or equal to (¾)·λ_{g} and less than or equal to (⅞)·λ_{g}, where, at a center frequency in a desired frequency band, a wavelength in the air is λ₀, a wavelength shortening coefficient of a glass is k, and the wavelength on the glass is λ_{g}=λ₀·k. By arranging the element length to be such a length, a preferable result can be obtained in a point to enhance the antenna gain.

Note that, when the first vertical element 129 is connected to the middle parts of the first horizontal element 127 and the second horizontal element 128, it is assumed that the element length such that the length from the first feeding point 121 to the end portion of the first antenna element 126 becomes maximum is the element length of the first antenna element 126.

Similarly, when the second vertical element 134 is connected to the middle parts of the third horizontal element 132 and the fourth horizontal element 133, it is assumed that the element length such that the length from the point connected to the area forming element 122 to the end portion of the second antenna element 131 becomes maximum is the element length of the second antenna element 131.

For example, if, as a desired frequency, an FM radio broadcast wave is selected, its center frequency is 90 MHz. Thus, if it is desired to enhance the antenna gain for the FM radio broadcast wave, it is desirable that the element length of the first antenna element 126 and the second antenna element 131 may be greater than or equal to 267 mm and less than or equal to 800 mm; and particularly preferably greater than or equal to 533 mm, and less than or equal to 800 mm, where the speed of the radio wave is 3.0×10⁸ m/s, and the wavelength shortening coefficient k is 0.64. Otherwise, it is desirable that the element length of the first antenna element 126 and the second antenna element 131 is greater than or equal to 1333 mm and less than or equal to 1866 mm; particularly preferably greater than or equal to 1600 mm and less than or equal to 1866 mm.

Here, it is assumed that, for a case where the first connecting element 130 is formed, the “element length of the first antenna element 126” includes the element length of the first connecting element 130. Similarly, it is assumed that, for a case where the second connecting element is formed, the “element length of the second antenna element 131” includes the element length of the second connecting element.

The first feeding point 121 is a part for electrically connecting, through a predetermined electrically conductive member, the first antenna conductor to a signal processing circuit, which is not depicted, such as an amplifier. As the electrically conductive member, a feeder line, such as an AV line, is used. A configuration may be adopted such that a connector for electrically connecting the signal processing circuit, such as an amplifier, to the first feeding point 121 is implemented in the first feeding point 121. By such a connector, it becomes easier to attach, for example, the AV line to the first feeding point 121.

Further, a configuration may be such that a protrusion-like electrically conductive member is installed in the first feeding point 121; and the protrusion-like electrically conductive member contacts or fits a connecting part, which is formed at a vehicle body flange to which the window glass plate 110 for the vehicle is to be attached.

Note that, in FIG. 1, the first feeding point 121 is formed on the area forming element 122; however, the first feeding point 121 is not limited to this embodiment. Namely, it can be located inside the closed area 123, or it can be located in the margin at the outer side, as long as it is electrically connected to the area forming element 122. Here, “electrically connected” includes, not only the fact that the first feeding point 121 and the area forming element 122 are mutually connected through a conductor, but also the fact that the first feeding point 121 and the area forming element 122 are conducted in a high-frequency manner, while the first feeding point 121 and the area forming element 122 are separated by a predetermined interval.

Additionally, the glass antenna 120 illustrated in FIG. 1 is connected to a filter circuit 164, which is surrounded by the dashed line. The filter circuit 164 includes coils 161 and 162; and a capacitor 163.

The coils 161 and 162 allow a direct electric current to pass through; however, the coils 161 and 162 block a signal in a frequency band received by the defogger. It suffices if the coils 161 and 162 are high-impedance, at least, for an AM band (520-1710 kHz); and it is desirable that they have impedance preferably greater than or equal to 1 kΩ in the entire AM band; and more desirable that they have impedance preferably greater than or equal to 2 kΩ. Further, a coil may be provided that exhibits high impedance for the AM band and the FM band.

The capacitor 163 prevents noise from a power supply in a frequency that is higher than the AM band from flowing in the first defogger 113 to affect the antenna gain in the FM band. It also prevents the noise from the power supply from flowing in the second defogger 116 to affect the antenna gain in the FM band. However, it is not limited to the embodiment; and if the noise from the power supply is small, the capacitor 163 may not be provided.

Further, an FM coil that exhibits high impedance for the FM band may be provided on the left bus bar of the first pair of bus bars 112, or in the middle of wiring from the left bus bar to the coil 161. Furthermore, an FM coil may be provided on the left bus bar of the second pair of bus bars 115, or in the middle of wiring from the left bus bar to the ground.

Additionally, an FM coil may be provided on the right bus bar of the first pair of bus bars 112, or in the middle of wiring from the right bus bar to the coil 162. Additionally, an FM coil may be provided on the right bus bar of the second pair of bus bars 115, or in the middle of wiring from the right bus bar to the power supply.

By providing such an FM coil, even higher gain can be obtained for the FM band.

As described above, the defogger is vertically divided, and a pattern is formed where a part of the above-described defogger is utilized as an antenna. Consequently, current capacity required for the coils 161 and 162 can be reduced, a small coil using a linear thin conductor can be used, and sufficient antenna gain for the FM band can be obtained.

Additionally, a second antenna conductor and a second feeding point 145 for the second antenna conductor may be provided, so that the glass antenna 120 can be a diversity antenna.

The second antenna conductor and the second feeding point 145 are formed at a lower portion of the second defogger 116, and the second antenna conductor includes a third antenna element and a fourth antenna element.

The third antenna element includes a fifth horizontal element 136 that is extended along the outer edge of the second defogger 116; and the third antenna element is connected to the second feeding point 145 through a third connecting element 135. One end of the third connecting element 135 is connected to the second feeding point 145; and the other end is connected to the fifth horizontal element 136.

Note that, in the embodiment, a configuration is indicated where the third antenna element is formed only of the fifth horizontal element 136; however, it is not limited to this, and an attached element may be provided.

Furthermore, in the embodiment, the example is indicated where the third connecting element 135 is connected to the edge of the fifth horizontal element to form an L-shape; however, it can be connected to a middle part of the fifth horizontal element 136 to form a T-shape; or it can be directly connected to the second feeding point 145 of the fifth horizontal element 136, without forming the third connecting element 135.

Further, in the embodiment, the fifth horizontal element 136 is extended along the second defogger 116, so that the fifth horizontal element 136 is proximate to the second defogger 116 to establish a capacitive coupling. By forming in such a manner, the obtained antenna gain is increased.

Furthermore, in FIG. 1, the third connecting element 135 is formed at a left side compared to the center line 150; however, depending on the location of the second feeding point 145, it may be formed at the left side, the right side, or both left and right sides.

The fourth antenna element includes a sixth horizontal element 138 that is extended along the outer edge of the second defogger 116; and a fourth connecting element 137 such that one end is connected to the sixth horizontal element 138, and the other end is connected to the second defogger 116.

In the embodiment, the sixth horizontal element 138 is located below the fifth horizontal element 136, and a part of it is capacitively coupled to the fifth horizontal element 136. By forming in such a manner, the obtained antenna gain is increased.

Further, in the embodiment, the fourth connecting element 137 extends from the right bus bar of the second pair of the bus bars 115, and the fourth connecting element 137 is connected to the edge of the sixth horizontal element 138, so that the fourth antenna element forms an L-shape; however, it is not limited to this embodiment. For example, the fourth connecting element 137 may extend from any position on the second plurality of heater lines 114, and it may be connected to a middle part of the sixth horizontal element 138 to form a T-shape.

Further, in FIG. 1, the fourth connecting element 137 is formed at a right side compared to the center line 150; however, it may be formed at a left side, the right side, or both left and right sides.

Here, it is desirable that the fifth horizontal element 136 of the above-described third antenna element and the sixth horizontal element 138 of the fourth antenna element are mutually capacitively coupled at one part. In the present specification, the portion where the fifth horizontal element 136 and the sixth horizontal element 138 are facing is defined to be a capacitively coupled part. By forming in such a manner, the obtained antenna gain is increased.

Additionally, in order to enhance the antenna gain, the elements described below may be provided.

For example, first short-circuit lines 143 may be formed, so that they vertically divides at least two lines of the first plurality of heater lines 111. By forming the first short-circuit lines 143 in this manner, the impedance of the first defogger 113 is adjusted, and the antenna gain is enhanced.

In the example of FIG. 1, the two short-circuit lines are horizontally symmetrically arranged with respect to the center line 150, as an axis; however arranged positions and a number of lines of the short-circuit lines are not limited to this embodiment. Namely, one short-circuit line may be provided on the center line 150; or three or more lines may be provided. The arranged positions may not be horizontally symmetrically arranged with respect to the center line 150, as an axis.

Furthermore, second short-circuit lines 144 may be provided, so that at least two lines of the second plurality of heater lines 114 are vertically divided. By providing the second short-circuit lines 144 in this manner, the impedance of the second defogger 116 is adjusted, and the antenna gain is enhanced.

In the example of FIG. 1, the two short-circuit lines are horizontally symmetrically arranged with respect to the center line 150, as an axis; however arranged positions and a number of lines of the short-circuit lines are not limited to this embodiment. Namely, one short-circuit line may be provided on the center line 150; or three or more lines may be provided. The arranged positions may not be horizontally symmetrically arranged with respect to the center line 150, as an axis.

Further, a first auxiliary conductor may be provided, which is to be arranged between the first defogger 113 and the second defogger 116. The first auxiliary conductor includes seventh horizontal elements 140 that are proximate to the first defogger 113, and that are extended along the first defogger 113 to establish a capacitive coupling; and fifth connecting elements 139, each of which is such that one end is connected to the seventh horizontal element 140, and the other end is connected to the second defogger 116.

In FIG. 1, two lines of the fifth connecting elements 139 extend from edges of the second short-circuit lines 144, respectively, and are joined to the edges of the two lines of the seventh horizontal elements 140, so that the first auxiliary conductor forms two L-shapes; however, it is not limited to this configuration. For example, the fifth connecting element 139 may be extended from any position on the second plurality of heater lines 114, and the fifth connecting element 139 may be joined to a middle part of the seventh horizontal element 140 to form a T-shape.

Further, in FIG. 1, the first auxiliary conductor is formed, so that the two lines of the seventh horizontal elements 140 and the two lines of the fifth connecting elements 139 are line-symmetry with respect to the center line 150, as an axis of symmetry; however, they may not be line-symmetry. Furthermore, the first auxiliary conductor may be one line of the horizontal element 140 and one line of the fifth connecting element 139.

Additionally, a second auxiliary conductor may be provided, which is to be arranged between the first defogger 113 and the second defogger 116.

The second auxiliary conductor includes an eighth horizontal element 142 that is proximate to the second defogger 116, and that is extended along the second defogger 116 to establish a capacitive coupling; and a sixth connecting elements 141 such that one end is connected to the eighth horizontal element 142, and the other end is connected to the first defogger 113.

In FIG. 1, the sixth connecting element 141 extends from the right bus bar of the first pair of bus bars 112, and it is joined to the edge of the eighth horizontal element 142, so that the second auxiliary conductor forms an L-shape; however, it is not limited to this configuration. For example, the sixth connecting element 141 may extend from any position on the first plurality of heater lines 111, and it may be joined to a middle part of the eighth horizontal element 142 to form a T-shape.

Further, in FIG. 1, the second auxiliary conductor is formed at a right side compared to the center line 150; however, it may be formed at a left side, or two lines may be formed at both left and right sides.

Here, it is desirable that the seventh horizontal element 140 of the above-described first auxiliary conductor and the eighth horizontal element 142 of the second auxiliary conductor are mutually capacitively coupled at one part.

In the present specification, a part where the seventh horizontal element 140 and the eighth horizontal element 142 are facing is defined to be a capacitively coupled part. By providing such first auxiliary conductor and second auxiliary conductor, the first defogger 113 and the second defogger 116 are connected in a high frequency manner through the first auxiliary conductor and the second auxiliary conductor, so that the obtained antenna gain is increased.

### Second Embodiment

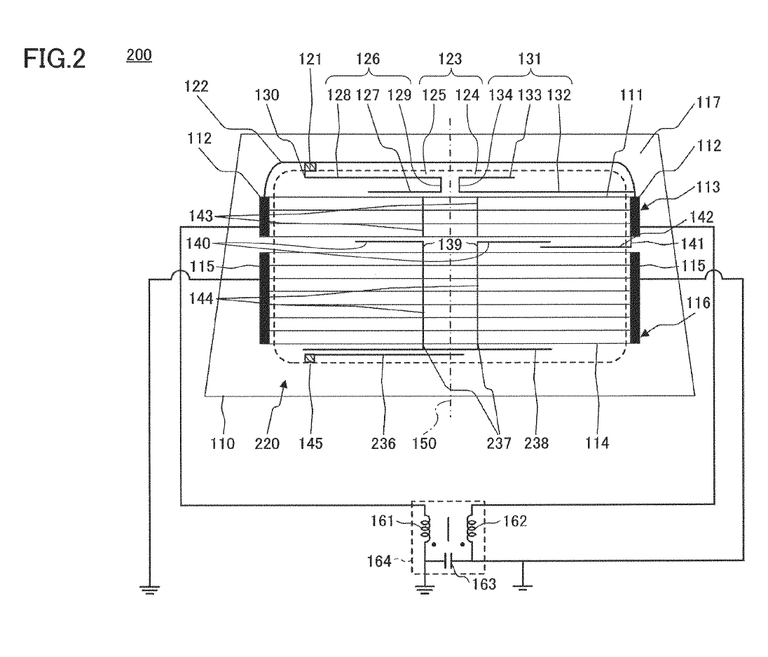

FIG. 2 is a plan view of a window glass 200 for a vehicle with a glass antenna, in which a glass antenna 220 according to a second embodiment of the present invention is formed.

As illustrated in FIG. 2, in the window glass plate 110 in which the glass antenna 220 is formed, for members having the same configurations as those of the window glass plate 110 in which the glass antenna 120 is formed, which is illustrated in above-described FIG. 1, reference numerals that are the same as the reference numerals of FIG. 1 are used. However, since configurations of the third antenna element and the fourth antenna element of the glass antenna 220 that are arranged below the second defogger 116 differ from those of the first embodiment illustrated in FIG. 1, for these portions, reference numerals that are obtained by adding 100 to the reference numerals of FIG. 1 are used.

In the second embodiment, the third antenna element includes a fifth horizontal element 236, whose one end is connected to the second feeding point 145, and which is extended along the outer edge of the second defogger 116.

In FIG. 2, the third antenna element is extended in a straight line from the second feeding point 145; and the third antenna element is formed below the fourth antenna element, which is described below. Further, the third antenna element is mainly formed at a left side compared to the center line 150; however, depending on a position of the second feeding point 145, the third antenna element may be mainly formed at a right side compared to the center line 150.

Furthermore, the fourth antenna element includes a sixth horizontal element 238 that is extended along the outer edge of the second defogger; and fourth connecting elements 237, each of which is such that one end is connected to a middle part of the fourth horizontal element 238, and the other end is joined to the second defogger 116.

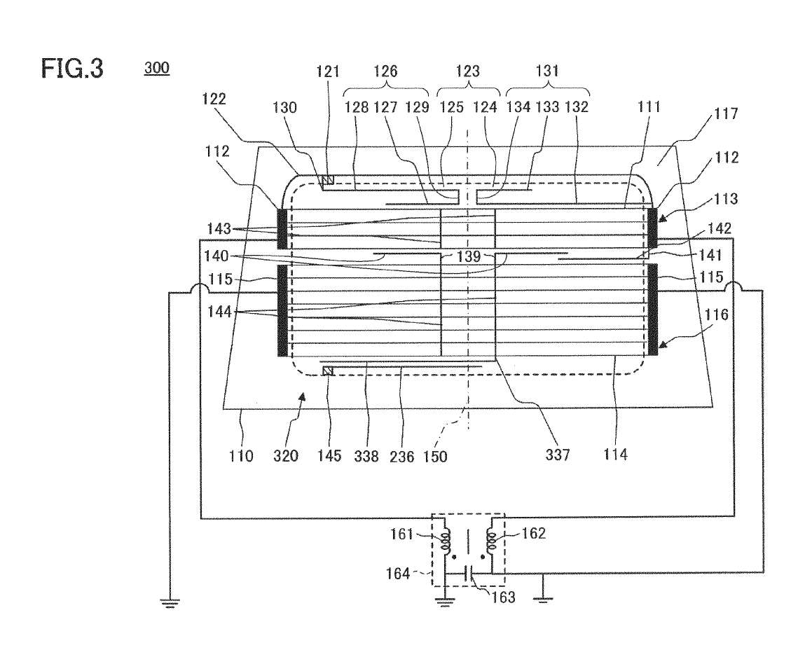

In FIG. 2, two lines of the fourth connecting elements 237 are formed; however, they are not limited to the embodiment. For example, an example is illustrated in FIG. 3, in which the specification of the second embodiment is modified.

FIG. 3 is a plan view of a window glass 300 for a vehicle with a glass antenna, in which a glass antenna 320 according to an example is formed, in which the specification of the second embodiment of the present invention is modified.

As shown in FIG. 3, a fourth connecting element 337 may be a single line, and the fourth connecting element 337 may be connected to an edge of a sixth horizontal element 338 to form an L-shape. Additionally, the fourth connecting element 337 may be two or more lines. Furthermore, the fourth connecting element 337 may be formed at any position on the second defogger 116.

Here, the first antenna conductor, the first feeding point 121, the second conductor, and the second feeding point 145 are formed by printing them with a paste including an electrically conductive metal, such as a silver paste, on a vehicle interior side surface of an window glass for a vehicle, for example, and baking them. However, it is not limited to this forming method; and a linear body or a foil body, which is formed of an electrically conductive material, such as copper, may be formed on a vehicle interior side surface of an window glass for a vehicle, it can be stuck on an window glass for a vehicle, for example, by an adhesive, or it can be formed inside an window glass for a vehicle itself.

The shapes of the first feeding point 121 and the second feeding point 145 may be determined depending on a shape of an implementation surface of the electrically conductive member or a connector. For example, a rectangular shape, such as a square, an approximate square, a rectangle, or an approximate rectangle, or a polygonal shape is preferable for implementation. Note that it may be a circular shape, such as a circle, an approximate circle, an ellipse, or an approximate ellipse.

Additionally, a glass antenna may be obtained by forming, inside or on a surface of a synthetic resin film, a conductor layer formed of the first antenna conductor and the second antenna conductor, and by forming the synthetic resin film with the conductor layer on a vehicle interior side surface or a vehicle exterior side surface of an window glass for a vehicle. Furthermore, a glass antenna may be obtained by forming, on a vehicle interior side surface of a window glass for a vehicle, a flexible circuit board in which the first antenna conductor and the second antenna conductor are formed.

### EXAMPLES

A rear window glass for a vehicle provided with a glass antenna was attached to an actual vehicle, and its antenna gain was actually measured. The results are described.

The rear window glass for a vehicle provided with the glass antenna was attached, in a state where it was tilted by approximately 35.4 degrees with respect to the horizontal plane, to a window frame of the vehicle, which was on a turntable; and the antenna gain was actually measured. Connectors were attached to the feeding points, and the feeding points were connected to a network analyzer through feeder lines. The turntable was rotated, so that radio waves were irradiated onto the rear window glass for a vehicle from any direction in the horizontal direction.

The measurement of the antenna gain was performed by rotating the vehicle by 360 degrees while setting the center of the vehicle, to which the rear window glass for a vehicle provided with the glass antenna was attached, to the center of the turntable. For the antenna gain data, values that were measured, for each frequency and for each rotational angle of 3 degrees, by rotating 360 degrees were averaged. Additionally, the antenna gain data was measured for each 1 MHz in the frequency range of the FM radio broadcast wave. The measurement was performed while setting the elevation angle between the transmit position of the radio waves and the antenna conductor to be approximately in the horizontal direction (when the elevation angle of the surface parallel to the ground is 0 degrees, and when the elevation angle of the zenith direction is 90 degrees, the direction where the elevation angle is 0 degrees). For the antenna gain, the voltage for 1 μV was used as the reference, and it was expressed in units of dB μV.

### Example 1

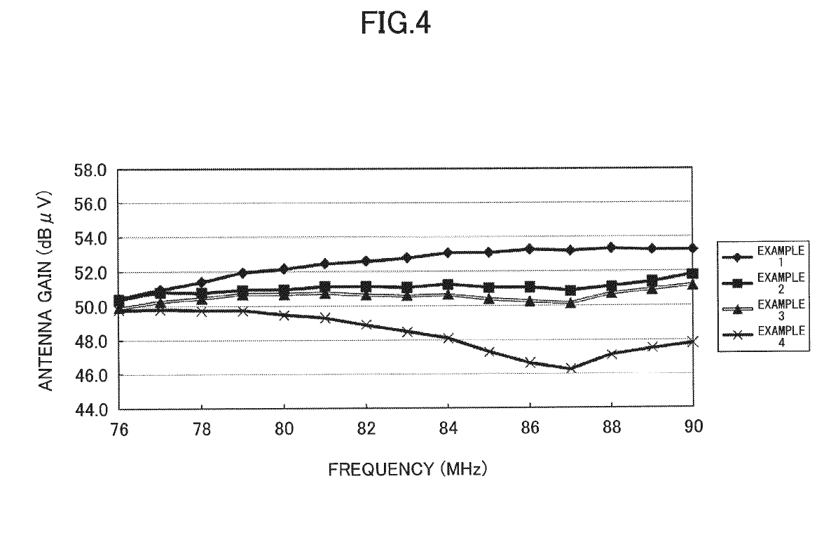

For the glass antenna 120 illustrated in FIG. 1, the effect on the antenna gain was examined for cases where the defogger was vertically divided and not divided without altering the patterns of other elements, and for cases where the area forming element 122 was formed and not formed. The results of measuring the antenna gain for corresponding cases are shown in FIG. 4. For FIG. 4, the antenna gain was measured for the horizontally polarized waves in the FM band (76-90 MHz) in Japan.

During actual measurement of FIG. 4, the lengths of the elements and the sizes of the components of the glass antenna 120 in units of mm were as follows:
the area forming element 122: 1030,
the first horizontal element 127: 280,
the second horizontal element 128: 365,
the first vertical element 129: 30,
the distance between the first defogger 113 and the first horizontal element 127: 10,
the third horizontal element 132: 495,
the fourth horizontal element 133: 140,
the second vertical element 134: 30,
the distance between the first defogger 113 and the second horizontal element 128: 10,
the fifth horizontal element 136: 600,
the distance between the second defogger 116 and the fifth horizontal element 136: 10,
the sixth horizontal element 138: 800,
the distance between the second defogger 116 and the sixth horizontal element 138: 30,
the length of the capacitively coupled part of the fifth horizontal element 136 and the sixth horizontal element 138: 450,
the distance between the first defogger 113 and the second defogger 116: 30,
the seventh horizontal element 140 (left): 380,
the seventh horizontal element 140 (right): 380,
the fifth connecting element 139 (left): 15,
the fifth connecting element 139 (right): 20,
the eighth horizontal element 142: 380,
the sixth connecting element 141: 20,
the length of the capacitively coupled part of the seventh horizontal element 140 and the eighth horizontal element 142: 295,
the distance between the first short-circuit line 143 and the center line 150: 100, and
the distance between the second short-circuit line 144 and the center line 150: 100.

Note here that, for the seventh horizontal element 140 and the fifth connecting element 139, the element formed at the left side is denoted by (left), and the element formed at the right side is denoted by (right), while setting the center line 150 as the center.

Further, a conductor width of each element was 0.4 mm. Each of the first feeding point 121 and the second feeding point 145 had a rectangular shape with vertical length of 14 mm and horizontal length of 20 mm. The inductance of each of the coils 161 and 162 was 1.3 mH, and the capacitance of the capacitor 163 was 4.7 μF. The conductor width of the elements, the shapes of the first feeding point 121 and the second feeding point 145, and the constants of the coils and the capacitors were the same for all of the following examples.

Furthermore, in FIG. 4, the explanatory notes were defined as follows: the case where the defogger was vertically divided, and the area forming element 122 was formed was “example 1,” the case where the defogger was vertically divided, and the area forming element 122 was not formed was “example 2,” the case where the defogger was not vertically divided and the area forming element 122 was formed was “example 3,” and the case were the defogger was not vertically divided and the area forming element 122 was not provided was “example 4.” Note that the conductor width of the elements, the sizes of the feeding points, and the explanatory notes were the same for all of the following examples.

As shown in FIG. 4, by vertically dividing the defogger, and by forming the area forming element 122, the results were obtained where the antenna gain was significantly enhanced over the entire frequency band of the domestic FM band.

### Example 2

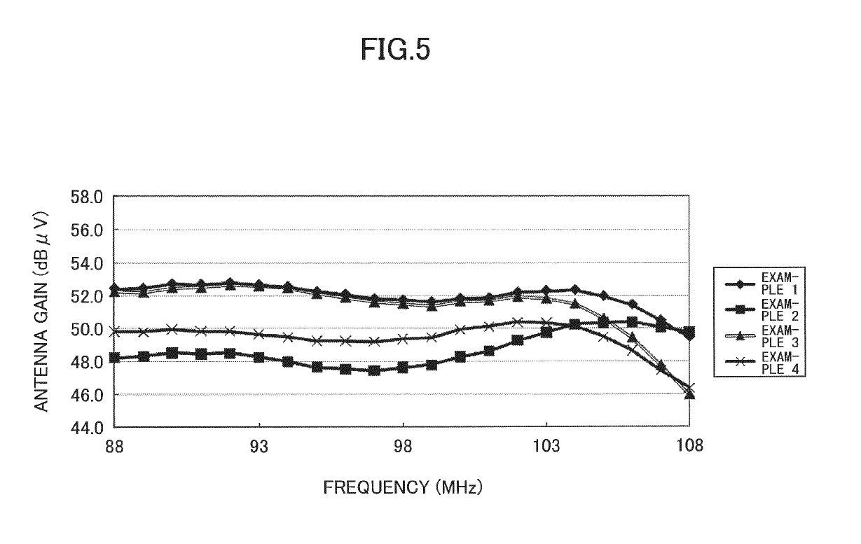

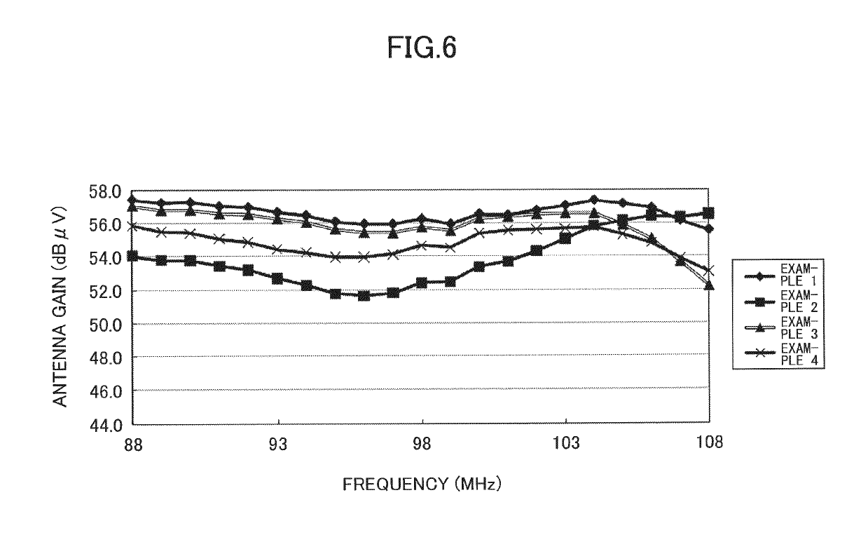

For the glass antenna 220 illustrated in FIG. 2, the effect on the antenna gain was examined for cases where the defogger was vertically divided and not divided without altering the pattern of each element, and for cases where the area forming element was formed and not formed without altering the patterns of the other elements. The results of measuring the antenna gain for corresponding cases are shown in FIG. 5 and FIG. 6. For FIG. 5, the antenna gain was measured for the horizontally polarized waves in the FM band (88-108 MHz) outside Japan; and for FIG. 6, the antenna gain was measured for the vertically polarized waves in the FM band (88-108 MHz) outside Japan.

During actual measurement of FIG. 5 and FIG. 6, the lengths of the elements and the sizes of the components of the glass antenna 220 in units of mm were as follows:
the area forming element 122: 1030,
the first horizontal element 127: 280,
the second horizontal element 128: 365,
the first vertical element 129: 30,
the distance between the first defogger 113 and the first horizontal element 127: 10,
the third horizontal element 132: 495,
the fourth horizontal element 133: 140,
the second vertical element 134: 30,
the distance between the first defogger 113 and
the second horizontal element 128: 10,
the fifth horizontal element 236: 440,
the distance between the second defogger 116 and the fifth horizontal element 236: 30,
the sixth horizontal element 238: 840,
the distance between the second defogger 116 and the sixth horizontal element 238: 15,
the distance between the first defogger 113 and the second defogger 116: 30,
the seventh horizontal element 140 (left): 210,
the seventh horizontal element 140 (right): 225,
the fifth connecting element 139 (left): 20,
the fifth connecting element 139 (right): 20,
the eighth horizontal element 142: 227,
the sixth connecting element 141: 20,
the length of the capacitively coupled part of the seventh horizontal element 140 and the eighth horizontal element 142: 18,
the distance between the first short-circuit line 143 and the center line 150: 100, and
the distance between the second short-circuit line 144 and the center line 150: 100.

As shown in FIG. 5 and FIG. 6, by vertically dividing the defogger and by forming the area forming element 122, as in example 1, the results were obtained where the antenna gain was significantly enhanced over the entire frequency band of the FM band outside Japan, though in example 2 where, simply, the defogger is vertically divided, the antenna gain was lowered compared to example 4 where the defogger is not vertically divided.

### Example 3

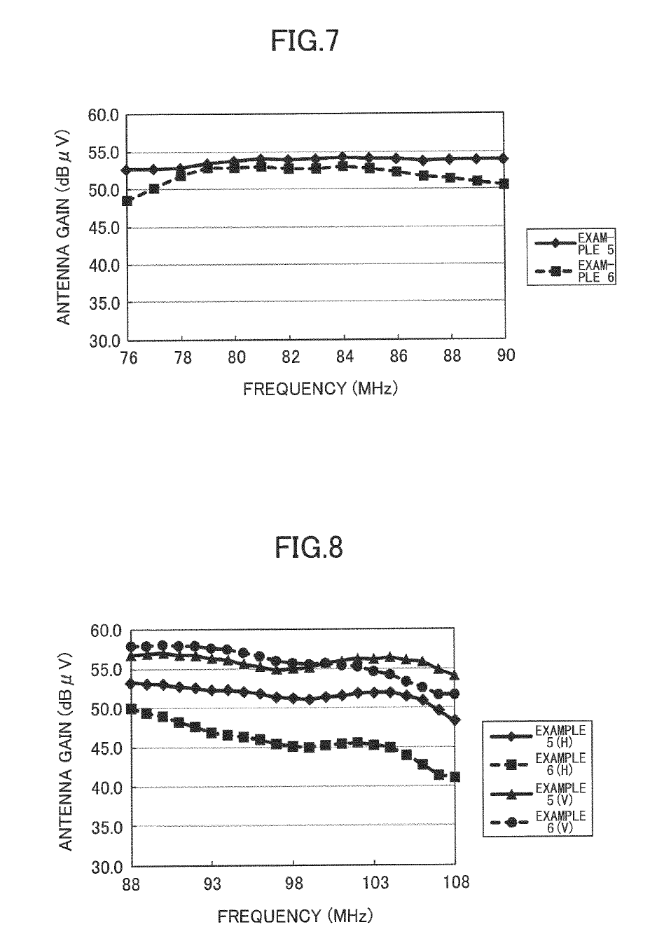

For the glass antenna 120 illustrated in FIG. 1, the results of measuring the antenna gain for the horizontally polarized waves in the FM band (76-90 MHz) in Japan are shown in FIG. 7.

During measurement of FIG. 7, the lengths of the elements and the sizes of the components of the glass antenna 120 were the same as those of during measurement of example 1. In FIG. 7, “example 5” indicates the gain (which is referred to as the main gain, hereinafter) by the first antenna element 126 and the second antenna element 131, which were the first antenna conductor; and “example 6” indicates the gain (which is referred to as the sub-gain, hereinafter) by the third antenna element and the fourth antenna element, which were the second antenna conductor for diversity reception. During measurement of FIG. 7, the lengths of the elements and the sizes of the components of the glass antenna 120 were the same as those of example 1.

From FIG. 7, the main gain was 53.7 dB μV on average, so that sufficiently high gain was obtained. Further, the sub-gain was 51.9 μV on average, so that sufficiently high gain was obtained.

### Example 4

For the glass antenna 320 illustrated in FIG. 3, the results of measuring the antenna gain for the horizontally polarized waves and the vertically polarized waves in the FM band (88-108 MHz) outside Japan are shown in FIG. 8. During measurement of FIG. 8, the lengths of the elements and the sizes of the components of the glass antenna 320 were:
the sixth horizontal element 338: 560,
where only the size that was different from that of during measurement of example 2 was noted.

In FIG. 8, “example 5 (H)” indicates the main gain for the horizontally polarized waves; “example 6 (H)” indicates the sub-gain for the horizontally polarized waves; “example 5 (V)” indicates the main gain for the vertically polarized waves; and “example 6 (V)” indicates the sub-gain for the vertically polarized waves.

As shown in FIG. 8, the main gain for the horizontally polarized waves was 51.8 dB μV on average, so that sufficiently high gain was obtained. Further, the sub-gain for the horizontally polarized waves was 46.1 dB μV on average, so that sufficiently high gain was obtained. Further, the main gain for the vertically polarized waves was 55.9 dB μV on average, so that sufficiently high gain was obtained. Furthermore, the sub-gain for the vertically polarized waves was 56 dB μV on average, so that sufficiently high gain was obtained.

1. A glass antenna for a vehicle such that a window glass plate of the vehicle is provided with an electric heating type defogger including a plurality of heater lines, and a plurality of bus bars for feeding power to the heater lines; a first antenna conductor; and a first feeding point for the first antenna conductor,
wherein the defogger is vertically divided, and the defogger includes a first defogger including a first plurality of heater lines and a first pair of bus bars, and a second defogger including a second plurality of heater lines and a second pair of bus bars,
wherein the first antenna conductor includes an area forming element, and a first antenna element,
wherein both edges of the area forming element are connected to the first defogger, and the area forming element is formed along an outer edge of the window glass plate to form a closed area that is closed by the area forming element and the first defogger,
wherein the first feeding point is electrically connected to the area forming element,
wherein the first antenna element is formed in the closed area, the first antenna element includes a first horizontal element, and the first antenna element is connected to the first feeding point directly or through a first connecting element, and
wherein the first horizontal element is proximate to the first defogger, and the first horizontal element extends along the first defogger.

2. The glass antenna for the vehicle according to claim 1, wherein the first antenna element includes a second horizontal element, and a first vertical element,
wherein the second horizontal element is extended parallel to the first horizontal element, while the second horizontal element is separated from the first horizontal element by a predetermined interval, and
wherein one end of the first vertical element is connected to the first horizontal element, and the other end of the first vertical element is connected to the second horizontal element.

3. The glass antenna according to claim 1, wherein the first antenna conductor includes a second antenna element,
wherein the second antenna element is formed in the closed area, the second antenna element includes a third horizontal element, and the second antenna element is connected to the area forming element directly or through a second connecting element, and
wherein the third horizontal element is proximate to the first defogger, and the third horizontal element extends along the first defogger.

4. The glass antenna for the vehicle according to claim 3, wherein the second antenna element includes a fourth horizontal element and a second vertical element,
wherein the fourth horizontal element is extended parallel to the third horizontal element, while the fourth horizontal element is separated from the third horizontal element by a predetermined interval, and
wherein one end of the second vertical element is connected to the third vertical element, and the other end of the second vertical element is connected to the fourth horizontal element.

5. The glass antenna according to claim 3, wherein the closed area is divided into a left closed area and a right closed area by a center line, as a boundary line, in a vertical direction, the center line passing through a centroid of the window glass plate,
wherein the first antenna element is formed in any one of the left closed area and the right closed area, and
wherein the second antenna element is formed in an area of the left closed area and the right closed area, the area being different from the area in which the first antenna element is formed.

6. The glass antenna for the vehicle according to claim 1, wherein an element length of the first antenna element is greater than or equal to (⅛)·λ_{g} and less than or equal to (⅜)·λ_{g}, or greater than or equal to (⅝)·λ_{g} and less than or equal to (⅞)·λ_{g},
wherein, at a center frequency in a desired frequency band, a wavelength in air is λ₀, a wavelength shortening coefficient of the window glass plate is k, and the wavelength on the window glass plate is λ_{g}=λ₀·k.

7. The glass antenna for the vehicle according to claim 1, wherein a second antenna conductor and a second feeding point for the second antenna conductor are formed below the second defogger,
wherein the second antenna conductor includes a third antenna element, and
wherein the third antenna element includes a fifth horizontal element that is extended along an outer edge of the second defogger, and the third antenna element is connected to the second feeding point directly or through a third connecting element.

8. The glass antenna for the vehicle according to claim 7, wherein the second antenna conductor includes a fourth antenna element, and
wherein the fourth antenna element includes a sixth horizontal element that is extended along the outer edge of the second defogger, and the fourth antenna element is connected to the second defogger through a fourth connecting element.

9. The glass antenna for the vehicle according to claim 8, wherein the third antenna element and the fourth antenna element are proximate each other to establish a capacitive coupling.

10. The glass antenna for the vehicle according to claim 1, further comprising:
a first auxiliary conductor,
wherein the first auxiliary conductor includes a seventh horizontal element, the seventh horizontal element being arranged between the first defogger and the second defogger, the seventh horizontal element being proximate to the first defogger, and the seventh horizontal element being extended along the first defogger, and
wherein the first auxiliary conductor includes a fifth connecting element, wherein one end of the fifth connecting element is connected to the seventh horizontal element, and the other end of the fifth connecting element is connected to the second defogger.

11. The glass antenna for the vehicle according to claim 1, further comprising:
a second auxiliary conductor,
wherein the second auxiliary conductor includes an eighth horizontal element, the eighth horizontal element being arranged between the first defogger and the second defogger, the eighth horizontal element being proximate to the second defogger, and the eighth horizontal element being extended along the second defogger, and
wherein the second auxiliary conductor includes a sixth connecting element, wherein one end of the sixth connecting element is connected the eighth horizontal element, and the other end of the sixth connecting element is connected to the first defogger.

12. The glass antenna for the vehicle according to claim 11, wherein the first auxiliary conductor and the second auxiliary conductor are proximate to each other to establish a capacitive coupling.

13. The glass antenna for the vehicle according to claim 1, further comprising:
a first short-circuit line that extends so as to vertically divide at least two lines of the first plurality of heater lines.

14. The glass antenna for the vehicle according to claim 1, further comprising:
a second short-circuit line that extends so as to vertically divide at least two lines of the second plurality of heater lines.

15. A window glass for a vehicle, the window glass comprising:
a glass antenna for the vehicle such that a window glass plate of the vehicle is provided with an electric heating type defogger including a plurality of heater lines, and a plurality of bus bars for feeding power to the heater lines; a first antenna conductor; and a first feeding point for the first antenna conductor,
wherein the defogger is vertically divided, and the defogger includes a first defogger including a first plurality of heater lines and a first pair of bus bars, and a second defogger including a second plurality of heater lines and a second pair of bus bars,
wherein the first antenna conductor includes an area forming element, and a first antenna element,
wherein both edges of the area forming element are connected to the first defogger, and the area forming element is formed along an outer edge of the window glass plate to form a closed area that is closed by the area forming element and the first defogger,
wherein the first feeding point is electrically connected to the area forming element,
wherein the first antenna element is formed in the closed area, the first antenna element includes a first horizontal element, and the first antenna element is connected to the first feeding point directly or through a first connecting element, and
wherein the first horizontal element is proximate to the first defogger, and the first horizontal element extends along the first defogger.

16. A glass antenna for a vehicle to be connected to a first defogger including a first plurality of heater lines and a first pair of bus bars, and to a second defogger including a second plurality of heater lines and a second pair of bus bars, the glass antenna for the vehicle comprising:
a first antenna conductor; and
a first feeding point for feeding power to the first antenna conductor,
wherein the first antenna conductor includes an area forming element, and a first antenna element,
wherein, when the area forming element is formed in a window glass plate, the area forming element is arranged along an outer edge of the window glass plate, and both edges of the area forming element are connected to the first defogger, so that a closed area that is closed by the area forming element and the first defogger is formed, and
wherein, when the first antenna element is formed in the window glass plate, the first antenna element is arranged in the closed area, and the first antenna element includes a part, the part being proximate to the first defogger, and the part being extended along the first defogger.
